(19) United States
(12) Patent Application Publication
(10) Pub. No.: US 2015/0251850 A1
(43) Pub. Date: Sep. 10, 2015

(54) PICKING FACILITY WITH RACK UNITS HAVING BUFFER JACKETS FOR PICKING ONTO A CENTRAL BAND

(71) Applicant: KNAPP AG, Hart bei Graz (AT)

(72) Inventors: Franz Mathi, Gleisdorf (AT); Peter Puchwein, Vasoldsberg (AT); Oliver Lehner, Graz (AT)

(21) Appl. No.: 14/438,135

(22) PCT Filed: Aug. 13, 2014
(86) PCT No.: PCT/EP2014/067338

§ 371 Date: Apr. 23, 2015

(30) Foreign Application Priority Data
Sep. 18, 2013 (AT) GM 50121/2013

(51) Int. Cl. B65G 1/137

(52) U.S. Cl. CPC B65G 1/1373

(57) ABSTRACT

The invention relates to a picking facility (1) having a controlling computer (2A) for picking products (P) for a picking order, wherein the picking facility (1) has at least one rack unit (3, 4) having two racks (R) for storing products (P) and a transport system provided in a rack lane (RG) formed by the two racks (R) for storing and collecting the products (P), and wherein products (P) that are collected from the racks (R) may be disposed onto a temporary storage place, and wherein there is provided a conveyor technology for conveying the products (P), wherein there are provided at least two buffer jackets (PU) as a temporary storage place, and that the controlling computer (2A) is configured to pick partial picking orders of the products (P) of a picking order that are contained in the racks (R) of a rack unit (3, 4) into respectively one of the buffer jackets (PU) and that the controlling computer (2A) is configured to combine the partial picking orders of a picking order onto the conveyor technology.

The invention relates to a picking facility having a controlling computer for picking products for a picking order, wherein the picking facility has at least one rack unit having two racks for storing products and a transport system provided in a rack lane formed by the two racks for storing and collecting the products, and wherein the products collected from the racks may be disposed on a temporary storage place and wherein there is provided a conveyor technology for conveying the products.

The invention further relates to a picking method for picking products.

The document WO 2011/151275 A1 discloses such a picking facility and such a picking method, wherein products are stored in a rack storage having several racks. Respectively two racks form a rack lane, in which there is provided a transport system for storing and collecting products. The picking facility has a goods-to-man working place, to which products collected from the rack storage and being part of a picking order are transported in order to being placed there by the working personnel in the appropriate quantities into an order container assigned to the picking order.

The picking facility known further has a central band technology having a central band and central band automats arranged along the central band. In these central band automats there is stored for each storage position one product type of a fast moving product that is frequently contained in picking orders and then picked, controlled by a controlling computer, at the correct point of time onto a central band section of the central band assigned to a picking order.

In order to enable refilling of the products stored in the rack storage into the central band automat, the picking facility known has through-channels and temporary storage places adjacent to these through-channels, in which the products collected from the rack storage are temporarily stored for refilling the central band automats. If there is danger of a product type running out of stock in a storage position of the central band automat, then an operator collects products of this product type from the temporary storage places and refills the central band automat.

With the picking facility known and the picking method known there has been given the disadvantage that slow moving products stored in the rack storage cannot be picked in an automated way and that fast moving products stored in the central band automat cannot be picked in an automated way together with the slow moving products.

The invention is based on the objective to enable the automated picking of products stored in a rack storage by means of a conveyor technology and in particular by means of a central band technology. According to the invention this objective is solved by providing at least two buffer jackets as a temporary storage place and by the controlling computer being configured to pick partial picking orders of the products of a picking order that are contained in the racks of a rack unit into respectively one of the buffer jacked and by the storage administration computer being configured to combine the partial picking orders of a picking order on the conveyor technology.

In this way, there is provided the advantage that the storage administration computer may collect the products of a picking order that are stored in the two racks of the rack unit by means of a transport system provided in the rack lane into a buffer jacket assigned to the picking order, which may then be temporarily stored there. As usually not all of the products of a picking order are stored in this rack unit and further products of the picking order have to be supplied from other rack units, the buffer jacket assigned to the picking order thus contains the products of a partial picking order. The controlling computer may initially pre-pick further partial picking orders from one or several rack units arranged at the conveyor technology into the further buffer jackets assigned to this picking order and subsequently combine these on the central band. The rack unit having the two racks and the transport system in the rack lane thereby represents an especially convenient and flexible unit in comparison with a rack storage having a plurality of racks and rack lanes.

The buffer jackets assigned to a picking order by the storage administration computer and arranged along the central band are controlled by the storage administration computer on-time so that these discharge the products of their partial picking orders onto a central band section of the central band assigned to the picking order. In addition, fast moving products may be picked from a central band automat, controlled by the storage administration computer, on-time onto the central band section of the picking order. This combination of the products of several partial picking orders from several rack units is enabled by using the buffer jackets as a temporary storage.

Hereby, there is given the advantage that slow moving products from the rack unit(s) as well as fast moving products, which are stored in central band automats, may be picked onto the central band in an automated way. The number of the rack units arranged along the central band may be increased more or less to any extent, and further partial picking orders of the picking order pre-picked with other picking types may be picked onto the central band.

It has also proven to be advantageous to use a conveyor technology, e.g., formed by a conveyor band, instead of the central band, on which order containers of the picking order are transported along the buffer jackets, wherein the products or the partial picking orders are picked from the buffer jackets immediately into the associated order container.

It has proven to be advantageous to provide a buffer band and/or buffer jackets for storing products in the rack unit. In this way, there is given the advantage that the transport system may collect products at any time and that it may store the products temporarily stored on the buffer band or the buffer jackets, respectively, only when there is no necessity to collect the products.

Further advantageous embodiments of the picking facility according to the invention and of the picking method according to the invention are explained in further detail in the following by way of the figures.

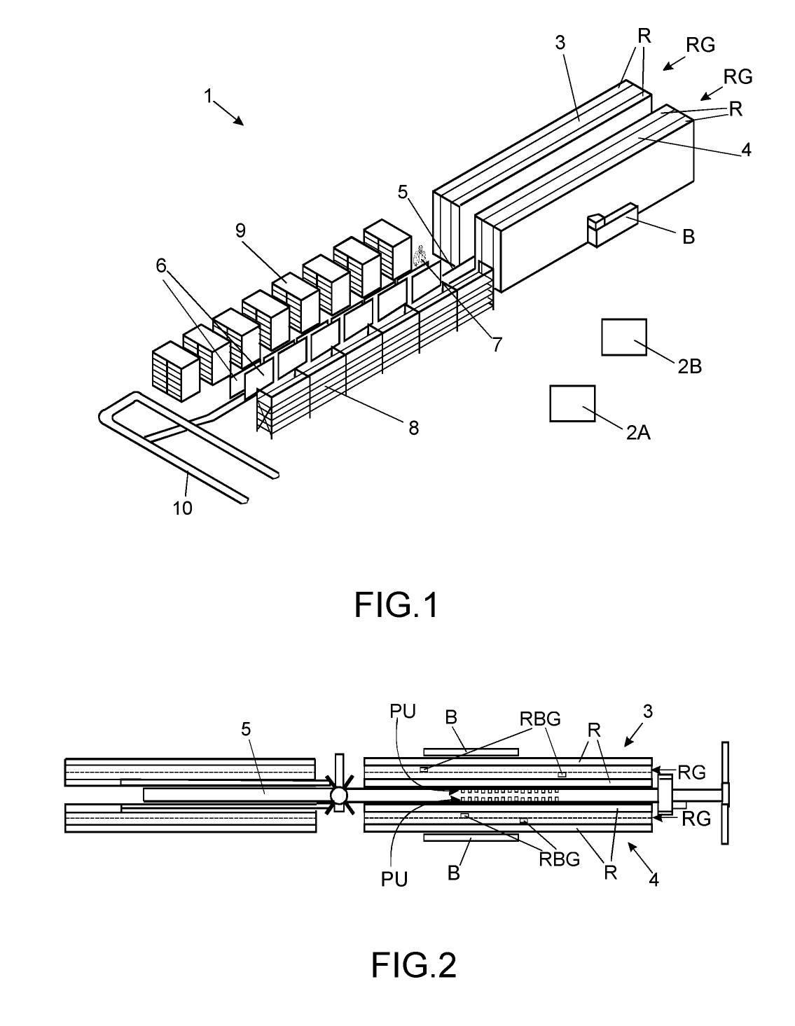

FIG. 1 shows an oblique view of a picking facility having two rack units along a central band.

FIG. 2 shows a top view of the picking facility according to FIG. 1.

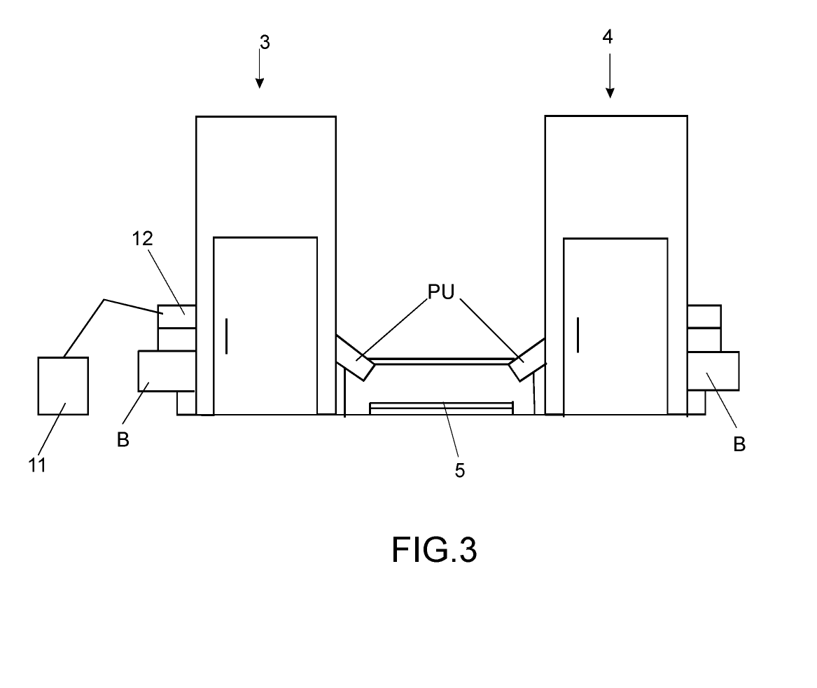

FIG. 3 shows a side view of the two rack units of the picking facility according to FIG. 1.

FIG. 1 shows a picking facility 1 having a controlling computer 2A and a storage administration computer 2B for picking products P for a picking order. The picking orders are supplied to the storage administration computer by an order computer for picking the products ordered. In the storage administration computer there is stored which product types are stored in which part of the storage. The picking facility 1 has two rack units 3 and 4, which each have two racks R for storing products and one rack lane RG formed by the racks R. In the rack lane RG there is provided a transport system for storing and collecting the products P. The transport system is formed by a rack operating device RBG known to those skilled in the art, which has for each rack R a vehicle moving on tracks having platforms adjustable in height for storing and collecting the products P in and from the rack R.

Each of the two rack units 3 and 4 has a buffer band B for storing products in one of the racks R. Products P to be stored are recognized by a scanner of the storage administration computer 2B and are fed to the rack operating devices RBG of the rack unit 3 or 4 for storing. In order guarantee on-time collection of the products P of a picking order, the storage administration computer 2B in the course of controlling the rack operating devices RBG always prefers collection orders and only accepts the storage of products P from the buffer band B into the respective storage place in one of the racks R if there is enough time. In this way there is given the advantage that picking orders may be performed especially quickly and reliably.

The two rack units 3 and 4 are now arranged at a central band 5 of a central band technology in order to combine products P of a picking order, so-called partial picking orders, that are collected from the respective rack unit 3 or 4 by means of the central band 5. For this reason, there is determined a central band section by the controlling computer 2A, onto which the products P of the picking order that are pre-picked in partial picking orders are discharged.

Each of the rack units 3 and 4 now has at least two buffer jackets PU as a temporary storage place, wherein the storage administration computer 2B assigns a buffer jacket PU to a picking order, when there is stored a product in the rack unit 3 or 4, which is to be picked for this picking order. These products are then, controlled by the controlling computer 2A, taken over by the rack operating device RBG from the storage place in the appropriate quantity and then disposed in the buffer jacket PU assigned to the picking order, thus combining partial picking orders.

In the rack units 3 and 4 there are stored so-called “slow moving goods”. These are products, which are not very often contained in picking orders. At the central band 5 there are also arranged central band automats 6, in which so-called “fast moving goods” are stored. Operators 7 refill products P from the racks 8 and 9 into the central band automat 6, if these are in danger of running out of stock. In this way, there is given the advantage that slow moving products P from the rack units 3 and 4 as well as fast moving products P from the central band automats 6 may be picked in an automated way onto the central band 5 by the picking facility 1.

The products P of the partial picking orders that are discharged onto the central band section of the central band are fed by a conveyor technology 10, on which there is transported at least on order container for each picking order. The central band 5 could also be substituted by a conventional conveyor band, on which order containers may be transported for each picking order and into which the partial picking orders may be directly discharged. The conveyor technology for transporting the order containers could also be realized by a lane conveyor vehicle or a suspension conveyor.

FIG. 3 shows a side view of the two rack units 3 and 4 according to FIG. 1. There are visible the buffer jackets PU that are obliquely inclined downwards, into which the rack operating devices RBG of the rack units 3 and 4 dispose the products P for a picking order and hence temporarily store until the discharge thereof onto the central band 5. Each rack unit 3 and 4 may have 5, 10, 20 or even 50 buffer jackets in order to enable the picking of several partial picking orders in parallel and subsequent temporarily storing thereof for a shorter or longer period of time.

There is provided a robot 11 for storing products P into the rack unit 3, which picks from the storage container disposed on the buffer band B also so-called return goods, this is products of different article types that are to be restored, and which disposes these into buffer jackets 12, sorted according to article type. If there is time, then the rack operating device RBG takes over the products P of one article type from one of the buffer jackets 12 and stores these in the storage place determined by the storage administration computer 2B. The robot 11 could also retrieve the products P from the storage container and dispose products P respectively of one product type onto a section of the buffer band B assigned to this product type by the storage administration computer 2B, which products P are then taken over and stored in the racks R by the rack operating device RBG.

When controlling, the controlling computer 3A uses a picking method for picking products P, wherein the following steps are performed. At first, products P of a picking order are collected from the rack unit 3 and/or 4, which each have two racks R and a transport system in the rack lane RG formed by the racks R. The products P of the picking order that are collected from the rack units 3 and 4 are picked into a buffer jacket PU assigned to the picking order as a partial picking order. Finally, the partial picking orders associated with a picking order are combined on a conveyor technology, in particular on the central band 5, by on-time discharge of the buffer jackets PU.

It is to be noted that the picking facility may be enlarged to any extent by further rack units arranged at the central band or at the conveyor technology. Similarly, further storage types (e.g., carousel storage) known to those skilled in the art may be arranged along the central band, from which products P may be discharged on-time as further partial picking orders onto the central band.

It is to be noted that there could also be provided level operating devices for each level of the rack R instead of the rack operating device in the rack unit, wherein the products collected would be handed over by the level operating devices to a lift and from there into the buffer jackets. Instead of the buffer jackets there could also be used comparable temporary storage systems (e.g., funnels, tubes) for temporarily storing the products collected from the rack unit.

It is to be noted that the distribution of the controlling operations between the storage administration computer and the controlling computer may also be distributed in another way, and also only one computer could assume both controlling operations.

1. A picking facility comprising:
a controlling computer for picking products for a picking order;
at least one rack unit having two racks for storing products;
a transport system for storing and collecting the products that is provided in a rack lane formed by the two racks, wherein the products collected from the racks may be disposed in a temporary storage place, and wherein a conveyor technology is provided for conveying the products; and
at least two buffer jackets as a temporary storage place, wherein the controlling computer is configured for picking partial picking orders of the products of a picking order, which are contained in the racks of a rack unit, into respectively one of the buffer jackets, and the controlling computer is configured to combine the partial picking orders of a picking order on the conveyor technology.

2. A picking facility according to claim 1, wherein the picking technology is formed by a central band technology, on the central band of which there may be determined by the controlling computer according to the picking order a central band section, into which the partial picking orders of a picking order are being picked.

3. A picking facility according to claim 1, wherein the conveyor technology is formed by a continuous conveyor or a lane conveyor vehicle or a suspension conveyor, and the conveyor technology is configured to transport at least one order container per picking order, into which the partial picking orders of the picking order are being picked, controlled by the controlling computer.

4. A picking facility according to claim 1, wherein the transport system is formed by a rack operating device, which has one vehicle for storing and collecting the products into and from the rack for each rack.

5. A picking facility according to claim 1, further comprising buffer band and/or buffer jackets for storing products into the rack unit, from which products placed on the buffer band and/or placed in the buffer jackets are taken over by the transport system and stored in the racks.

6. A picking facility according to claim 5, further comprising a robot for storing products onto the buffer band and/or the buffer jackets.

7. A picking facility according to claim 6, wherein a storage container with products to be stored in the racks is fed to the robot, wherein the robot is configured to collect different product types from the storage container and to dispose the products respectively of one product type onto one section of the buffer band assigned to this product type by a storage administration computer and/or into a buffer jacket assigned by the storage administration computer.

8. A picking facility according to claim 1, further comprising a continuous conveyor and/or a lane conveyor and/or a suspension conveyor for storing the products.

9. A picking facility according to claim 2, further comprising central band automats provided along the central band, which are configured to dispose products of the picking order onto the central band section assigned to the picking order, controlled by the controlling computer.

10. A picking facility according to claim 1, further comprising at least one further rack unit along the conveyor technology, wherein the controlling computer is configured to pick partial picking orders from these two rack units onto the conveyor band.

11. A picking method for picking products, comprising the following steps:
collecting products of a picking order from a rack unit having two racks and a transport system in the rack lane formed by the racks;
picking products of the picking order that are stored in the rack unit in a buffer jacket assigned to the picking order as a partial picking order; and
combining the partial picking orders being part of a picking order on a conveyor technology, in particular on a central band, by on-time discharging of the buffer jackets.
